(19) United States
(12) Patent Application Publication
(10) Pub. No.: US 2018/0096811 A1
(43) Pub. Date: Apr. 5, 2018

(54) CONTACT MECHANISM OF ELECTROMAGNETIC RELAY

(71) Applicant: DELTA ELECTRONICS, INC., Taoyuan City (TW)

(72) Inventors: Ming-Tsung Lee, Taoyuan City (TW); Tsung-Hsuen Wu, Taoyuan City (TW); Ching-Hsiang Tien, Taoyuan City (TW)

(21) Appl. No.: 15/399,575

(22) Filed: Jan. 5, 2017

(30) Foreign Application Priority Data
Oct. 4, 2016 (TW) 105132056

(51) Int. Cl. H01H 51/04; H01H 45/04; H01H 45/14

(52) U.S. Cl. CPC H01H 51/04; H01H 45/14; H01H 45/04

(57) ABSTRACT

A contact mechanism of an electromagnetic relay comprises a contact assembly, a movable contact assembly and a driving unit. The contact assembly comprises a bottom plate, an upper case disposed on the bottom plate, and two stationary contact heads disposed on and penetrating the upper case. The movable contact assembly comprises a central axis passing through the contact assembly, a movable contact plate disposed on the top portion of the central axis and configured to contact with or separate from the two stationary contact heads, and a cover element covering the central portion of the central axis. The driving unit is disposed around the lower portion of the central axis and configured to drive the central axis to move back and forth along the axial direction for allowing the movable contact plate to contact with or separate from the two stationary contact heads.

### FIELD OF THE INVENTION

The present invention relates to a contact mechanism, and more particularly to a contact mechanism of an electromagnetic relay.

### BACKGROUND OF THE INVENTION

Recently, electromagnetic relay has been widely used in many fields, such as home appliance, industry, or automobile. The electromagnetic relay is employed to control a high-voltage working circuit through a low-voltage control circuit. That is, the electromagnetic relay is provided with a low voltage by the low-voltage control circuit, and the operation status of the high-voltage working circuit is controlled through the internal structure of the electromagnetic relay by means of electromagnetic principle.

FIG. 1 is a cross-sectional view illustrating an electromagnetic relay of a prior art. As shown in FIG. 1, the conventional electromagnetic relay 1 includes a contact assembly 11, a movable contact assembly 12, a driving assembly 13, and a winding coil 14. The contact assembly 11 includes a bottom plate 111, an upper case 112, and two stationary contact heads 113. The upper case 112 is disposed on the bottom plate 111. The bottom plate 111 has a through hole (not shown) for allowing a central axis 122 of the movable contact assembly 12 to pass through the bottom plate 111. Each of the two stationary contact heads 113 has a portion embedded in the upper case 112 and the other portion extending outwardly from the upper case 112 for electrically connecting with an external circuit. The movable contact assembly 12 includes a movable contact plate 121 and the central axis 122. The central axis 122 passes through a through hole (not shown) of the movable contact plate 121, and a top tip of the central axis 122 penetrates the movable contact plate 121 and is disposed on the movable contact plate 121. The driving assembly 13 is disposed around the lower portion of the central axis 122, and the driving assembly 13 is fixed to a lower tip of the central axis 122. The winding coil 14 is disposed around the peripheral edge of the driving assembly 13. When the winding coil 14 draws current, the driving assembly 13 can drive the movable contact assembly 12 to move back and forth along the perpendicular direction for allowing the movable contact plate 121 of the movable contact assembly 12 to move upwardly to contact with the stationary contact heads 113, or to move downwardly to separate from the stationary contact heads 113. Consequently, the electrical conduction or interruption of the external circuit connected with the stationary contact heads 113 is controlled by the electromagnetic relay 1.

However, the stationary contact heads 113 and the movable contact plate 121 of the electromagnetic relay 1 are contacted with and separated from each other frequently, so that the stationary contact heads 113 and the movable contact plate 121 of the electromagnetic relay 1 may generate tiny dust or powder for long time use. Due to that the connection between the central axis 122 and the driving assembly 13 are performed by means of simple axis-and-hole combination, it is unavoidable to form gaps between the central axis 122 and the driving assembly 13. Under this circumstance, tiny dust or powder enters into the space between the central axis 122 and the driving assembly 13 through the gaps easily, and the gaps are blocked by the tiny dust or powder. Consequently, the movement of the central axis 122 is limited due to the accumulated dust or powder and the electromagnetic relay 1 fails to work.

In addition, if unexpected surge current flows through the stationary contact heads 113 and the movable contact plate 121 connected to the stationary contact heads 113 during the operation of the electromagnetic relay 1, the movable contact plate 121 is subject to a force along a direction from the stationary contact heads 113 to the bottom plate 111. Under this circumstance, there may be a gap formed between the stationary contact heads 113 and the movable contact plate 121, and the electric arc may be generated between the stationary contact heads 113 and the movable contact plate 121. Consequently, the stationary contact heads 113 and the movable contact plate 121 are welded together, which may result in the damage of the electromagnetic relay 1.

Therefore, there is a need of providing a contact mechanism of electromagnetic relay, so as to obviate the drawbacks encountered from the prior arts.

### SUMMARY OF THE INVENTION

It is an object of the present invention to provide a contact mechanism of electromagnetic relay for solving the problems of not smooth operation or stuck of the central axis which are caused by the accumulation of tiny dust or powder generated between the stationary contact head and the movable contact plate after long time use, and for avoiding the problem of the contact points being welded together due to the gap generated between the stationary contact head and the movable contact plate when surge current flows through the stationary contact head and the movable contact plate.

It is another object of the present invention to provide a contact mechanism of electromagnetic relay for allowing the central axis of the contact mechanism to operate smoothly, allowing the stationary contact head and the movable contact plate to smoothly contact with and separate from each other after being used for long time, and allowing the central axis to move back to the original position with buffer.

In accordance with an aspect of the present invention, a contact mechanism of electromagnetic relay is provided. The contact mechanism includes a contact assembly, a movable contact assembly and a driving unit. The contact assembly includes a bottom plate, an upper case and two stationary contact heads. The bottom plate has a through hole. The upper case is disposed on the bottom plate and forms an accommodation space with the bottom plate. Two stationary contact heads are disposed on and penetrate the upper case correspondingly. The movable contact assembly comprises a central axis, a movable contact plate and a cover element. The central axis passes through the through hole of the contact assembly and has a top portion, a central portion and a lower portion. The movable contact plate is disposed on the top portion of the central axis and configured to contact with or separate from the two stationary contact heads. The cover element covers the central portion of the central axis. The driving unit is disposed around the lower portion of the central axis and configured to drive the central axis of the movable contact assembly to move back and forth along the axial direction for allowing the movable contact plate of the movable contact assembly to contact with or separate from the two stationary contact heads of the contact assembly.

In accordance with another aspect of the present invention, a contact mechanism of electromagnetic relay is provided. The contact mechanism includes a contact assembly, a movable contact assembly and a driving unit. The contact assembly comprises a bottom plate, an upper case and two stationary contact heads. The bottom plate has a through hole. The upper case is disposed on the bottom plate and forms an accommodation space with the bottom plate. The two stationary contact heads are disposed on and penetrate the upper case correspondingly. The movable contact assembly comprises a central axis, a movable contact plate, a magnet core assembly and a cover element. The central axis passes through the through hole of the contact assembly and has a top portion, a central portion and a lower portion. The movable contact plate is disposed on the top portion of the central axis and configured to contact with or separate from the two stationary contact heads. The magnet core assembly comprises an upper magnet core and a lower magnet core. The upper magnet core abuts against an upper edge of the top portion of the central axis, and the upper magnet core is disposed on a first surface of the movable contact plate. The lower magnet core penetrates the top portion of the central axis, and the lower magnet core is disposed around the top portion of the central axis and disposed on a second surface of the movable contact plate. The cover element covers the central portion of the central axis. The driving unit is disposed around the lower portion of the central axis and configured to drive the central axis of the movable contact assembly to move back and forth along the axial direction for allowing the movable contact plate of the movable contact assembly to contact with or separate from the two stationary contact heads of the contact assembly.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a cross-sectional view illustrating the structure of a electromagnetic relay of a prior art;

FIG. 2A is a schematic view illustrating the structure of the contact mechanism of electromagnetic relay according to a preferred embodiment of the present invention;

FIG. 2B is a schematic perspective view illustrating the contact mechanism without the upper case and the tubular element of FIG. 2A;

FIG. 3 is a cross-sectional view illustrating the contact mechanism along the section line A-A′ of FIG. 2B;

FIG. 4 is a partial enlarged schematic perspective view illustrating the contact mechanism according to a preferred embodiment of the present invention;

FIG. 5A is a schematic view illustrating the structure of the cover element according to a preferred embodiment of the present invention when the cover element is compressed; and

FIG. 5B is a schematic view illustrating the structure of the cover element according to a preferred embodiment of the present invention when the cover element is not compressed.

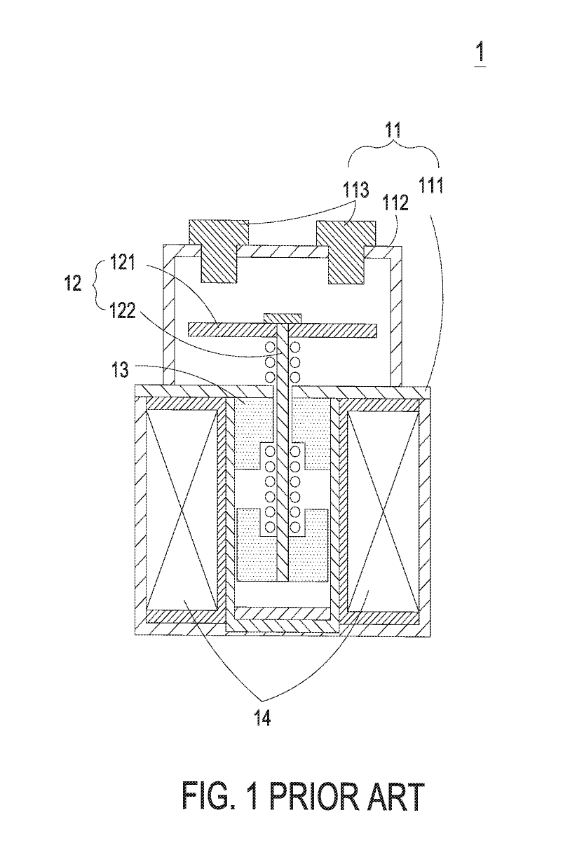

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

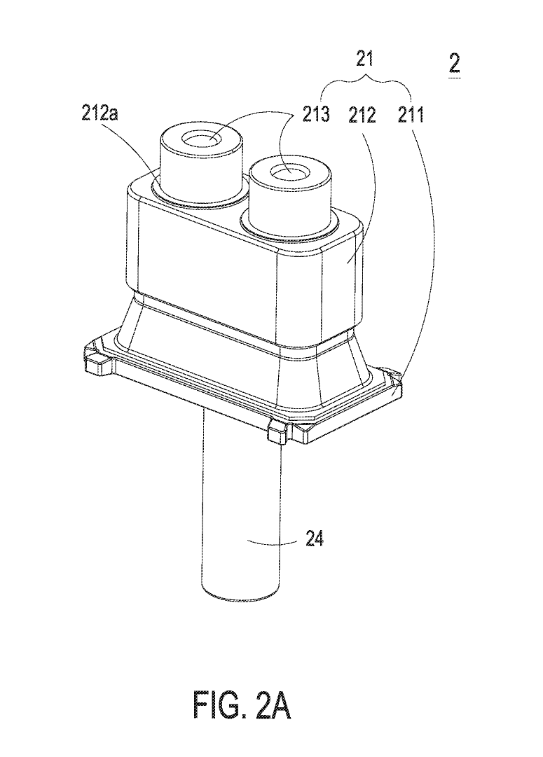

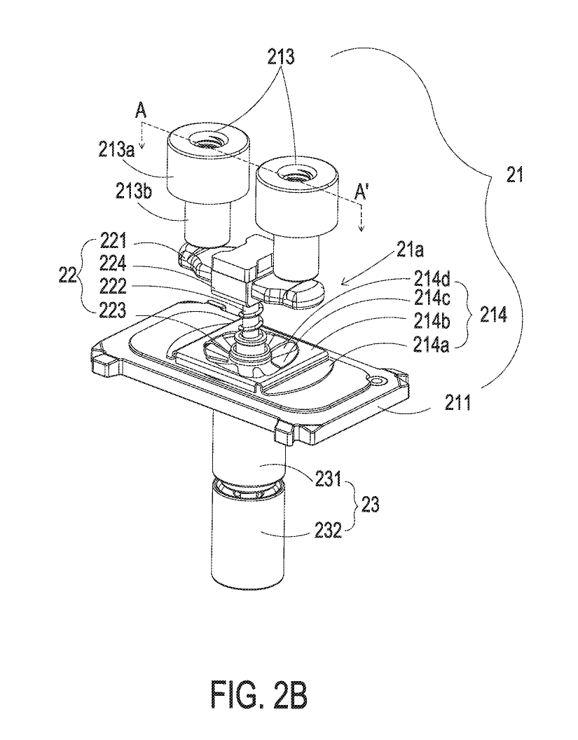

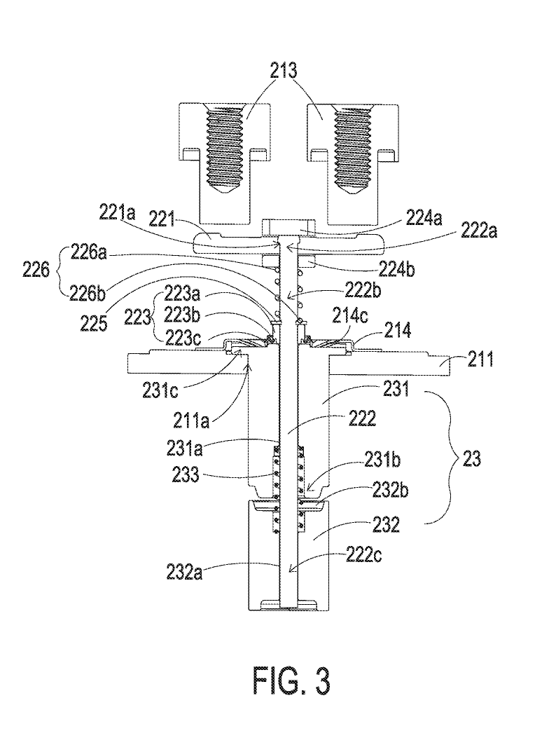

FIG. 2A is a schematic view illustrating the structure of the contact mechanism of electromagnetic relay according to a preferred embodiment of the present invention. FIG. 2B is a schematic perspective view illustrating the contact mechanism without the upper case and the tubular element of FIG. 2A. As shown in FIGS. 2A and 2B, the contact mechanism 2 of the present invention is applicable to an electromagnetic relay and includes a contact assembly 21, a movable contact assembly 22 and a driving unit 23. Please refer to FIG. 2A, the contact assembly 21 includes a bottom plate 211, an upper case 212 and two stationary contact heads 213. Preferably but not exclusively, the bottom plate 211 is a plate structure and has a through hole 211a (as shown in FIG. 3) located at a central area. The upper case 212 is disposed on the bottom plate 211. Preferably but not exclusively, the upper case 212 is a hollow structure with an opening, and the upper case 212 and the bottom plate 211 form an accommodation space 21a for accommodating a movable contact assembly 22. The two stationary contact heads 213 are disposed on and penetrate the upper case 212 correspondingly. As shown in FIG. 2B, preferably but not exclusively, both the two stationary contact heads 213 are cylindrical and nail-shaped structure, and each of the two stationary contact heads 213 has a connecting part 213a and a linking part 213b. In this embodiment, the diameter of the connecting part 213a is larger than the diameter of the linking part 213b, and the diameter of the connecting part 213a is also larger than or equal to the diameter of the through hole 212a of the upper case 212. Consequently, when the stationary contact head 213 is inserted into the through hole 212a, the connecting part 213a with larger diameter is stuck on the upper surface of the upper case 212, and the linking part 213b passes through the through hole 212a of the upper case 212 and is accommodated in the accommodation space 21a. Consequently, the connecting part 213a can be connected to an external working circuit, and the linking part 213b is used for connecting with or separating from a movable contact plate 221.

Please refer to FIG. 2B. The contact head assembly 22 includes a movable contact plate 221, a central axis 222 and a cover element 223. Preferably but not exclusively, the movable contact plate 221 is a plate structure, and is made of conductive material, for example, metal. In addition, the movable contact plate 221 has a through hole 221a (as shown in FIG. 3) for accommodating the central axis 222. The central axis 222 passes through the through hole 211a of the bottom plate 211 of the contact assembly 21 and has a top portion 222a, a central portion 222b and a lower portion 222c. The movable contact plate 221 is disposed on the top portion 222a (as shown in FIG. 3) of the central axis 222, and two sides of the movable contact plate 221 are configured to contact with or separate from the two linking parts 213b of the two stationary contact heads 213. Preferably but not exclusively, the cover element 223 is an elastic cap structure. The cover element 223 covers the central portion 222b of the central axis 222, and the cover element 223 is stretched or compressed along with the displacement of the central axis 222. Namely, the cover element 223 is deformed along with the displacement of the central axis 222. Consequently, the cover element 223 can cover the connection area between the central portion 222b of the central axis 222 and the blocking element 214, so that the central portion 222b is isolated from the environment, and the connection area between the central portion 222b of the central axis 222 and the blocking element 214 is dust-proof.

As shown in FIGS. 2B and 3, the driving unit 23 is disposed around the lower portion 222c of the central axis 222 and is configured to drive the central axis 222 of the movable contact assembly 22 to move back and forth along the axial direction. Therefore, the driving unit 23 can drive the movable contact plate 221 of the movable contact assembly 22 to move upwardly to contact with the two linking parts 213b of the two stationary contact heads 213 of the contact assembly 21, or move downwardly to separate from the two linking parts 213b of the two stationary contact heads 213 of the contact assembly 21. Consequently, the electrical conduction or interruption of the external working circuit connected to the two connecting parts 213a of the two stationary contact heads 213 can be controlled by the electromagnetic relay.

As shown in FIG. 2A, in this embodiment, preferably but not exclusively, the contact mechanism 2 of the present invention further includes a tubular element 24 and the tubular element 24 is a tube-shaped structure. The tubular element 24 is disposed around the driving unit 23 for positioning and covering the driving unit 23. When the electromagnetic relay with the contact mechanism 2 is operated, the driving unit 23 doesn't directly contact the winding coil (not shown) disposed outside the driving unit 23, and the driving unit 23 can be electrically isolated and drive the movable contact assembly 22 smoothly.

FIG. 3 is a cross-sectional view illustrating the contact mechanism along the section line A-A′ of FIG. 2B. As shown in FIGS. 2B and 3, in this embodiment, preferably but not exclusively, the driving unit 23 includes a static iron core 231, a movable iron core 232 and a first elastic element 233. The static iron core 231, the first elastic element 233 and the movable iron core 232 are disposed around the central axis 222 in sequence. The static iron core 231 is a cylindrical structure and has a first axial passage 231a for accommodating the central axis 222. The static iron core 231 is securely connected with the bottom plate 211 and can restrict the movement of the movable iron core 232. Preferably but not exclusively, the movable iron core 232 is also a cylindrical structure and has a second axial passage 232a for accommodating the central axis 222. The movable iron core 232 is securely connected with the central axis 222, so that the central axis 222 can be driven to move back and forth along the axial direction. The first elastic element 233 is preferably but not exclusively a spring, and is disposed between the static iron core 231 and the movable iron core 232 for providing a repulsive force between the static iron core 231 and the movable iron core 232. The static iron core 231 is separated from the movable iron core 232 by the repulsive force when the electromagnetic relay is disabled. Consequently, the movable contact plate 221 of the movable contact assembly 22 is separated from the two linking part 213b of the two stationary contact heads 213 and returned to the original position.

In this embodiment, preferably but not exclusively, the static iron core 231 includes a first protrusion 231b and a disk part 231c, and the movable iron core 232 includes a first recess 232b. The first protrusion 231b and the disk part 231c are disposed on the two sides of the static iron core 231 respectively. The first recess 232b is disposed on the upper side of the movable iron core 231 and faces to the first protrusion 231b. Preferably but not exclusively, the structures of the first protrusion 231b and the first recess 232b can be two match shapes such as circle or polygonal. It is noted that the structures of the first protrusion 231b and the first recess 232b are not limited to the above embodiment, and can be varied according to the practical requirements. In some embodiments, the static iron core 231 and the movable iron core 232 can contact with each other by two flat surfaces. When the electromagnetic relay is enabled, the first protrusion 231b of the static iron core 231 is accommodated in the first recess 232b of the movable iron core 23. The movement between the static iron core 231 and the movable iron core 232 can be guided through the first protrusion 231b and the first recess 232b. Consequently, the movable iron core 232 can stably move back and forth repeatedly. Moreover, the diameter of the disk part 231c disposed on the top side of the static iron core 231 is slightly larger than the diameter of the through hole 211a of the bottom plate 211. Therefore, when the driving unit 23 is disposed around the lower portion 222c of the central axis 222 of the movable contact assembly 22, a lower surface of the disk part 231c is flatly abutted to an upper surface around the through hole 211a of the bottom plate 211. Consequently, the static iron core 231 can be directly hanged on the bottom plate 211 through the disk part 231c.

When the contact mechanism 2 is disposed in an electromagnetic relay, the driving unit 23 is passed through and disposed in a winding coil (not shown), that is, the winding coil (not shown) surrounds the peripheral edge of the driving unit 23. When the winding coil (not shown) draws current, the operation of the driving unit 23 can be controlled by means of electromagnetic principle. When the winding coil (not shown) draws current, a magnetic field and an attractive force are generated between the static iron core 231 and the movable iron core 232. Due to that the static iron core 231 is securely connected to the bottom plate 211, the static iron core 231 is stationary with respect to the movable iron core 232. Under this circumstance, the movable iron core 232 is attracted and moved toward the static iron core 231, and the first elastic element 233 is compressed. At this moment, due to that the movable iron core 232 is securely connected to the central axis 222, when the movable iron core 232 moves, the central axis 222 is moved by the movable iron core 232. Consequently, when the movable iron core 232 is attracted by the static iron core 231 to move upwardly, the central axis 222 is dragged by the movable iron core 232 to move upwardly. The two sides of the movable contact plate 221 disposed on the central axis 222 are in contact with the two stationary contact heads 213 of the contact assembly 21, and the external working circuit connected to the two stationary contact heads 213 is conducted. On the contrary, when the winding coil (not shown) fails to draw current, the magnetic field in the driving unit 23 disappears, and the attractive force also disappears. Meanwhile, the first elastic element 233 is no longer compressed by the movable iron core 232, and is returned to the original shape by the restoring force. Then the movable iron core 232 is pushed downwardly, and the movable iron core 232 carries the central axis 222 and the movable contact plate 221 to move downwardly. Consequently, the two sides of the movable contact plate 221 disposed on the central axis 222 is separated from the two stationary contact heads 213 of the contact assembly 21, and the external working circuit connected to the two stationary contact heads 213 is shut off.

Please refer to FIGS. 2B and 3. In this embodiment, preferably but not exclusively, the contact assembly 21 of the contact mechanism 2 further includes a blocking element 214, and the blocking element 214 is a plate with two bending sides. The blocking element 214 has two engaging portions 214a, an abutting portion 214b and a plurality of sub-blocking element 214c. The two bending sides of the blocking element 214 are defined as the engaging portions 214a, and the engaging portions 214a are flatly disposed on the bottom plate 211. Preferably but not exclusively, each of the sub-blocking elements 214c is a clamping structure extended from the edge of the hole 214d located on the center of the abutting portion 214b. The sub-blocking elements 214b are bended toward the static iron core 231 of the driving unit 23, and are abutted against the disk part 231c of the static iron core 231. Consequently, the displacement of static iron core 231 that may happen during the operation of the electromagnetic relay can be avoided, and the static iron core 231 can be steadily fixed on the bottom plate 211.

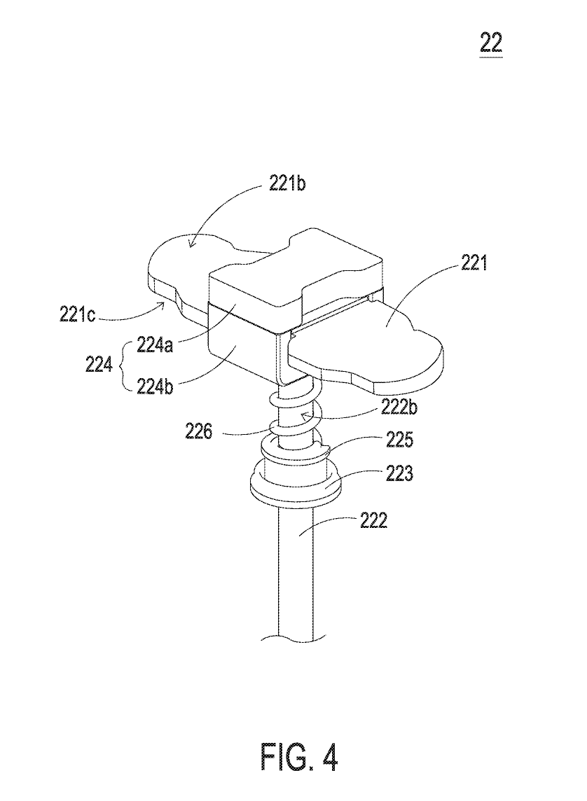

FIG. 4 is a partial enlarged schematic perspective view illustrating the contact mechanism according to a preferred embodiment of the present invention. As shown in FIG. 4, in this embodiment, preferably but not inclusively, the movable contact assembly 22 includes a movable contact plate 221, a central axis 222, a cover element 223, a magnet core assembly 224, an E-shaped ring 225 and a second elastic element 226. The elements and functions of the movable contact plate 221, the central axis 222 and the cover element 223 are similar to those of FIGS. 2A, 2B and 3, and are not redundantly described herein. In this embodiment, the magnet core assembly 224 includes an upper magnet core 224a and a lower magnet core 224b. Preferably but not exclusively, the upper magnet core 224a is a plate structure, and the lower magnet core 224b is a U-shaped structure. In some embodiments, the upper magnet core 224a and the lower magnet core 224b can be two corresponding “U” shape structures or two corresponding “L” shape structures. The upper magnet core 224a is abutted against the top edge of the top portion 222a of the central axis 222 (as shown in FIG. 3) and a first surface 221b of the movable contact plate 221. In this embodiment, the upper magnet core 224a and the top portion 222a of the central axis 222 are fixed together by welding. It is noted that the method of combining the upper magnet core 224a with the top portion 222a of the central axis 222 is not limited to welding, the upper magnet core 224a and the top portion 222a of the central axis 222 can also be fixed together by the way of using corresponding screw and screw hole. The lower magnet core 224b, the second elastic element 226 and the E-shaped ring 225 are disposed on the central portion 222b of the central axis 222 in sequence. The lower magnet core 224b is passed through and disposed around the top portion 222a of the central axis 222, and the lower magnet core 224b is also abutted against the second surface 221c of the movable contact plate 221. By using the lower magnet core 224b and the upper magnet core 224a, the movable contact plate 221 is clamped between the upper magnet core 224a and the lower magnet core 224b. The E-shaped ring 225 is securely disposed around the central portion 222b of the central axis 222. In this embodiment, preferably but not exclusively, the method of fixing the E-shaped ring 225 is slotting a recess on the central axis 222 firstly, and then putting the E-shaped ring into the recess of the central axis 222. The second elastic element 226 is disposed around the central portion 222b of the central axis 222, and is disposed between the magnet core assembly 224 and the E-shaped ring 225. In addition, as shown in FIG. 3, the second elastic element 226 has a first end 226a and a second end 226b, the first end 226a is abutted against the lower surface of the lower magnet core 224b, and the second end 226b is abutted against the E-shaped ring 225. Please refer to FIGS. 3 and 4, when the electromagnetic relay is disabled, the second elastic element 226 is compressed to provide the lower magnet core 224b with a force which is toward the upper magnet core 224a. Consequently, the movable contact plate 221 is tightly clamped between the upper magnet core 224a and the lower magnet core 224b. When surge current flows through the two stationary contact heads 213 and the movable contact plate 221, the magnetic field generated by this current allows the upper magnet core 224a and the lower magnet core 224b of the magnet core assembly 224 to attract each other. Due to that the upper magnet core 224a is securely connected to the central axis 222, the upper magnetic core 224a is stationary with respect to the lower magnet core 224b. At this moment, the lower magnet core 224b moves upwardly toward the upper magnet core 224a, and the movable contact plate 221 will be clamped more tightly. Consequently, the movable contact plate 221 will not be pushed away from the two stationary contact heads 213 by the repulsive force caused by the surge current, and the welding of contact points between the two stationary contact heads 213 and the movable contact plate 221 can be avoided.

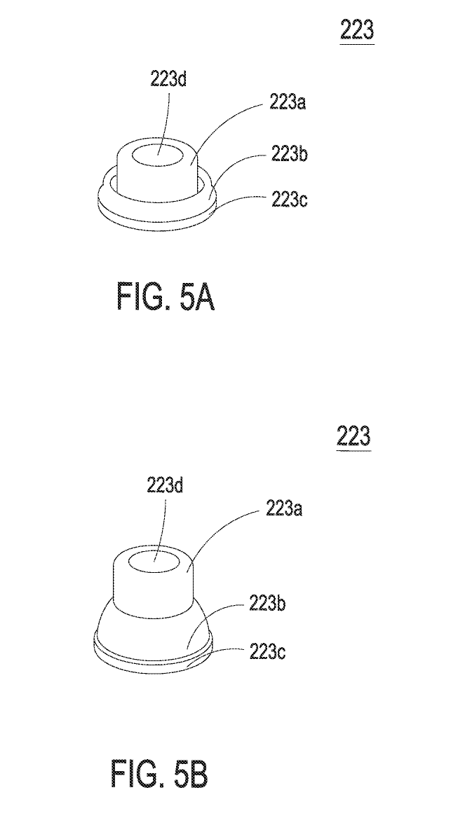

FIG. 5A is a schematic view illustrating the structure of the cover element according to a preferred embodiment of the present invention when the cover element is compressed, and FIG. 5B is a schematic view illustrating the structure of the cover element according to a preferred embodiment of the present invention when the cover element is not compressed. As shown in FIGS. 5A and 5B, the cover element 223 is made of silicon, but it is not limited. Other materials that are elastic and compressible can also be employed. In this embodiment, the cover element 223 is a cap structure and has a head portion 223a, a connecting portion 223b, a circular bottom portion 223c and a through hole 223d. The connecting portion 223b is connected with the head portion 223a and the circular bottom portion 223c, and is disposed between the head portion 223a and the circular bottom portion 223c. The through hole 223d penetrates through the head portion 223a, the connecting portion 223b and the circular bottom portion 223c. As shown in FIGS. 3 and 5A, the diameter of the through hole 223d is equal to the diameter of the central axis 222. When the cover element 223 is disposed around the central axis 222, the head portion 223a covers the outer edge of the central axis 222. The connecting portion 223b and the circular bottom portion 223c which are gradually widen are disposed on the connection area between the cover element 223 and the blocking element 214. Two ends of the connecting portion 223b are respectively connected to the head portion 223a and the circular bottom portion 223c. The diameter of the head portion 223a is equal to the diameter of the central axis 222, and the diameter of the circular bottom portion 223c is slightly larger than the diameter of the central axis 222, and the connecting portion 223b is deformed along with the movement of the central axis 222. For example, in this embodiment, when the winding coil (not shown) of the electromagnetic relay is not energized, as shown in FIG. 5A, the cover element 223 of the movable contact assembly 22 is compressed. When the winding coil (not shown) of the electromagnetic relay is energized, as shown in FIG. 5B, the cover element 223 of the movable contact assembly 22 is not compressed.

Please refer to FIGS. 3, 5A and 5B. When the cover element 223 is disposed between the bottom plate 211 of the contact assembly 21 and the movable contact plate 221 of the movable contact assembly 22, the head portion 223a of the cover element 223 is abutted to the lower surface of the E-shaped ring 225 of the movable contact assembly 22, and the circular bottom portion 223c of the cover element 223 is abutted to the disk part 231c of the static iron core 231. In this embodiment, preferably but not exclusively, the diameter of the circular bottom portion 223c of the cover element 223 of the movable contact assembly 22 is less than the diameter of a circle defined by the tips of the sub-blocking elements 214c of the blocking element 214 of the contact assembly 21. In some embodiments, the diameter of the circular bottom portion 223c of the cover element 223 of the movable contact assembly 22 is equal to the diameter of a circle defined by the tips of the plurality of sub-blocking elements 214c of the blocking element 214 of the contact assembly 21, that is, the outer edge of the cover element 223 is in contact with the sub-blocking elements 214c of the blocking element 214 of the contact assembly 21. Consequently, the cover element 223 of the present invention can continuously cover the gap between the central axis 222 and the upper magnet core 231, and the stuck problem of the central axis 222 caused by the accumulation of tiny dust or powder between the stationary contact heads 213 and the movable contact plate 221 can be avoided.

Please refer to FIGS. 2A, 2B and 3. The operation of the contact mechanism 2 of the present invention is described as following. When the contact mechanism 2 is disposed in the electromagnetic relay, the lower portion 223c of the central axis 222 of the movable contact assembly 22 is disposed in and surrounded by a winding coil (no shown), and the two stationary contact heads 213 of the contact assembly 21 are connected to the external working circuit. Then, when the winding coil (not shown) draws current, the static iron core 232 of the driving unit 23 drives the central axis 222 to move upwardly and the movable contact plate 221 disposed on the central axis 222 are also moved upwardly. Consequently, the two sides of the movable contact plate 221 are connected to the two stationary contact heads 213 of the contact assembly 21, and the external working circuit connected to the two stationary contact heads 213 is conducted. Meanwhile, the cover element 223 is extended along with the upward movement of the central axis 222, so that the cover element 223 can prevent the tiny dust or powder generated between the movable contact plate 221 and the stationary contact heads 213 from falling into the gap between the central axis 222 and the driving unit 23. On the contrary, when the winding coil fails to draw current, the movable iron core 232 will no longer push the central axis 222 upwardly and will be pushed back to the original position by the first elastic element 233. At the same time, the cover element 223 is compressed and deformed as the central axis 222 moves downwardly, so that the cover element 223 can serve as a buffer for the central axis 222 during the downward movement. On the other hand, if surge current flows through the electromagnetic relay when the electromagnetic relay is operating, the contact mechanism 2 can utilize the magnet core assembly 224 disposed around the top portion 222a of the central axis 222 to tightly clamp the movable contact plate 221. Consequently, the possible welding problem of contact points between the two stationary contact heads 213 and the movable contact plate 221 can be avoided. The contact mechanism 2 utilizes the cover element 223 and the magnet core assembly 224 to make sure that the tiny dust or powder generated from the contact points of the circuit will not affect the operation of electromagnetic relay, and the damage caused by the surge current can be avoided.

In conclusion, by utilizing the cover element, the contact mechanism of the present invention can avoid the problems of not smooth operation or stuck of central axis which are caused by the tiny dust or powder generated between the stationary contact head and the movable contact plate stuck after long time use, and can also avoid the problem of the contact points being welded together due to a gap generates between the stationary contact head and the movable contact plate when surge current flows through the stationary contact head and the movable contact plate. In addition, the inventive contact mechanism of electromagnetic relay can be operated stably and reliably after long time use.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A contact mechanism of an electromagnetic relay, the contact mechanism comprising:
a contact assembly, comprising:
a bottom plate having a through hole;
an upper case disposed on the bottom plate and forming an accommodation space with the bottom plate; and
two stationary contact heads disposed on and penetrating the upper case correspondingly;
a movable contact assembly, comprising:
a central shaft passing through the through hole of the contact assembly and having a top portion, a central portion and a lower portion;
a movable contact plate disposed on the top portion of the central shaft and configured to contact with or separate from the two stationary contact heads; and
a cover element covering the central portion of the central shaft, wherein the cover element is deformed along with the movement of the central shaft; and
a driving unit disposed around the lower portion of the central shaft and configured to drive the central shaft of the movable contact assembly to move back and forth along the axial direction for allowing the movable contact plate of the movable contact assembly to contact with or separate from the two stationary contact heads of the contact assembly.

2. The contact mechanism of the electromagnetic relay according to claim 1, wherein the driving unit comprises:
a static iron core securely connected with the bottom plate and having a first axial passage for accommodating the central shaft;
a movable iron core securely connected with the central shaft and having a second axial passage for accommodating the central shaft; and
a first elastic element disposed between the static iron core and the movable iron core for providing a repulsive force between the static iron core and the movable iron core, wherein the static iron core is separated from the movable iron core, and the movable contact plate of the movable contact assembly is separated from the two stationary contact heads of the contact assembly when the electromagnetic relay is disabled.

3. The contact mechanism of the electromagnetic relay according to claim 2, wherein the static iron core of the driving unit comprises a first protrusion, the movable iron core comprises a first recess, wherein when the electromagnetic relay is enabled, the first protrusion is accommodated in the first recess.

4. The contact mechanism of the electromagnetic relay according to claim 2, wherein the contact assembly comprises a blocking element disposed on the bottom plate, and the blocking element comprises a plurality of sub-blocking elements, wherein the sub-blocking elements are bended toward the static iron core for blocking the static iron core.

5. The contact mechanism of the electromagnetic relay according to claim 4, wherein the cover element comprises a head portion, a connecting portion, and a circular bottom portion, and the connecting portion is connected with the head portion and the circular bottom portion and disposed between the head portion and the circular bottom portion.

6. The contact mechanism of the electromagnetic relay according to claim 5, wherein the diameter of the circular bottom portion of the cover element is less than or equal to the diameter of a circle defined by the tips of the plurality of sub-blocking elements.

7. The contact mechanism of the electromagnetic relay according to claim 1, wherein the movable contact assembly comprises a magnet core assembly comprising an upper magnet core and a lower magnet core, wherein the upper magnet core abuts against an upper edge of the top portion of the central shaft, and the upper magnet core is disposed on a first surface of the movable contact plate, the lower magnet core penetrates the top portion of the central shaft, and the lower magnet core is disposed around the top portion of the central shaft and disposed on a second surface of the movable contact plate.

8. The contact mechanism of the electromagnetic relay according to claim 7, wherein the movable contact assembly comprises a second elastic element, the second elastic element is disposed around the central portion of the central shaft, and a first end of the second elastic element abuts against a lower surface of the lower magnet core.

9. The contact mechanism of the electromagnetic relay according to claim 8, wherein the movable contact assembly comprises an E-shaped ring, the E-shaped ring is disposed around the central portion of the central shaft, and a second end of the second elastic element abuts against the E-shaped ring.

10. The contact mechanism of the electromagnetic relay according to claim 1, wherein the movable contact assembly comprises a tubular element, and the tubular element is disposed around the driving unit.

11. A contact mechanism of an electromagnetic relay, the contact mechanism comprising:
a contact assembly, comprising:
a bottom plate having a through hole;
an upper case disposed on the bottom plate and forming an accommodation space with the bottom plate; and
two stationary contact heads disposed on and penetrating the upper case correspondingly;
a movable contact assembly, comprising:
a central shaft passing through the through hole of the contact assembly and having a top portion, a central portion and a lower portion;
a movable contact plate disposed on the top portion of the central shaft and configured to contact with or separate from the two stationary contact heads;
a magnet core assembly comprising an upper magnet core and a lower magnet core, wherein the upper magnet core abuts against an upper edge of the top portion of the central shaft, and the upper magnet core is disposed on a first surface of the movable contact plate, the lower magnet core penetrates the top portion of the central shaft, and the lower magnet core is disposed around the top portion of the central shaft and disposed on a second surface of the movable contact plate; and
a cover element covering the central portion of the central shaft, wherein the cover element is deformed along with the movement of the central shaft; and
a driving unit disposed around the lower portion of the central shaft and configured to drive the central shaft of the movable contact assembly to move back and forth along the axial direction for allowing the movable contact plate of the movable contact assembly to contact with or separate from the two stationary contact heads of the contact assembly.

12. The contact mechanism of the electromagnetic relay according to claim 11, wherein the driving unit comprises:
a static iron core securely connected with the bottom plate and having a first axial passage for accommodating the central shaft;
a movable iron core securely connected with the central shaft and having a second axial passage for accommodating the central shaft; and
a first elastic element disposed between the static iron core and the movable iron core for providing a repulsive force between the static iron core and the movable iron core, wherein the static iron core is separated from the movable iron core, and the movable contact plate of the movable contact assembly is separated from the two stationary contact heads of the contact assembly when the electromagnetic relay is disabled.

13. The contact mechanism of the electromagnetic relay according to claim 12, wherein the static iron core of the driving unit comprises a first protrusion, the movable iron core comprises a first recess, wherein when the electromagnetic relay is enabled, the first protrusion is accommodated in the first recess.

14. The contact mechanism of the electromagnetic relay according to claim 12, wherein the contact assembly comprises a blocking element disposed on the bottom plate, and the blocking element comprises a plurality of sub-blocking elements, wherein the sub-blocking elements are bended toward the static iron core for blocking the static iron core.

15. The contact mechanism of the electromagnetic relay according to claim 14, wherein the cover element comprises a head portion, a connecting portion, and a circular bottom portion, and the diameter of the circular bottom portion of the cover element is less than or equal to the diameter of a circle defined by the tips of the plurality of sub-blocking elements.
